(19) United States
(12) Patent Application Publication
(10) Pub. No.: US 2026/0196953 A1
(43) Pub. Date: Jul. 9, 2026

(54) DRIVE CONTROL SYSTEM

(71) Applicant: SHIMADZU CORPORATION, Kyoto-shi (JP)

(72) Inventors: Daiki FUKUSHIMA, Kyoto-shi (JP); Yusaku OMURA, Kyoto-shi (JP)

(21) Appl. No.: 19/439,151

(22) Filed: Jan. 2, 2026

(30) Foreign Application Priority Data
Jan. 9, 2025 (JP) 2025-003522

(51) Int. Cl. H02P 8/38

(52) U.S. Cl. CPC H02P 8/38

(57) ABSTRACT

A drive control system includes a drive device that has a stepping motor and a displaceable part, and a control device. The control device outputs a first command to the stepping motor to displace the displaceable part in a first direction, performs a first determination to determine a step-out of the stepping motor based on the first command, and at the position where the displaceable part has finished displacing based on the first command, outputs a second command to the stepping motor to displace the displaceable part in a second direction different from the first direction, performs a second determination to determine a step-out of the stepping motor based on the second command, and if the stepping motor is in a first state where it steps out both when it receives the first command and when it receives the second command, outputs a first abnormality signal indicating the first state.

### TECHNICAL FIELD

The present disclosure relates to a drive control system.

### BACKGROUND ART

An example of a method for determining whether a stepping motor has stepped out is disclosed in Japanese Unexamined Patent Application Publication No. 2009-261045 (Patent Literature 1). This method involves measuring the back electromotive force of the stepping motor's coil and determining whether the stepping motor has stepped out based on whether the measurement result meets a predetermined criterion.

### CITATION LIST

### PATENT LITERATURE

Patent Literature 1 Japanese Unexamined Patent Application Publication No. 2009-261045

### SUMMARY OF INVENTION

### TECHNICAL PROBLEM

Among the controls for a stepping motor is an origin search, which is a control to find the origin of the rotational position of the stepping motor. In an origin search, a command to rotate the stepping motor is output, causing a displaceable part that is displaced by the rotation of the stepping motor to abut against a restriction member, thereby causing the stepping motor to step out. The position of the displaceable part when the step-out occurs is recognized as the origin.

For example, if the displaceable part that is displaced by the rotation of the stepping motor is stuck to a surrounding component, a step-out will occur even when the displaceable part is not in contact with the restriction member. Hereinafter, a step-out that occurs when the displaceable part is not in contact with the restriction member will also be referred to as an "abnormal step-out." If an abnormal step-out occurs during the execution of an origin search, the position of the displaceable part at the time of the abnormal step-out will be mistakenly recognized as the origin, and the origin search cannot be executed correctly. Therefore, it is desirable to determine whether an abnormal step-out will occur and to execute the origin search only if it is determined that an abnormal step-out will not occur. However, Japanese Unexamined Patent Application Publication No. 2009-261045 (Reference 1) makes no mention of such a problem or its solution.

The present invention has been made to solve such problems, and its objective is to determine whether an abnormal step-out of a stepping motor will occur.

### SOLUTION TO PROBLEM

A drive control system according to the present disclosure includes a drive device and a control device that controls the drive device. The drive device has a stepping motor that rotates upon receiving a command from the control device, and a displaceable part connected to the stepping motor, which is displaced by the rotation of the stepping motor. The control device outputs a first command to the stepping motor to displace the displaceable part in a first direction, performs a first determination to determine a step-out of the stepping motor (10) based on the first command, and at the position where the displaceable part (20) has finished displacing based on the first command, outputs a second command to the stepping motor to displace the displaceable part in a second direction different from the first direction, performs a second determination to determine a step-out of the stepping motor (10) based on the second command, and if the stepping motor is in a first state where it steps out both when it receives the first command and when it receives the second command, outputs a first abnormality signal indicating that it is in the first state.

### ADVANTAGEOUS EFFECTS OF INVENTION

According to the present disclosure, it is possible to determine whether an abnormal step-out of a stepping motor will occur.

### BRIEF DESCRIPTION OF DRAWINGS

FIG. 1 is a diagram schematically showing a configuration of a drive control system according to the present embodiment.

FIG. 2 is a flowchart showing an example of a procedure for the control device to control the drive device.

FIG. 3 is a diagram showing an example of the output torque of the stepping motor at the time of step-out versus the current value flowing through the stepping motor.

FIG. 4 is a diagram showing an example of the back electromotive force acquired by the control device.

FIG. 5 is a flowchart showing an example of a procedure for determining whether the stepping motor has stepped out based on the value of the back electromotive force.

FIG. 6 is a flowchart showing an example of a procedure for the control device to control the drive device in Modification 1.

FIG. 7 is a flowchart showing an example of a procedure for the control device to control the drive device in Modification 2.

### DESCRIPTION OF EMBODIMENTS

Hereinafter, the present embodiment will be described in detail with reference to the drawings. In the following description, the same or corresponding parts in the drawings are denoted by the same reference numerals, and their description will not be repeated.

### Configuration of Drive Control System

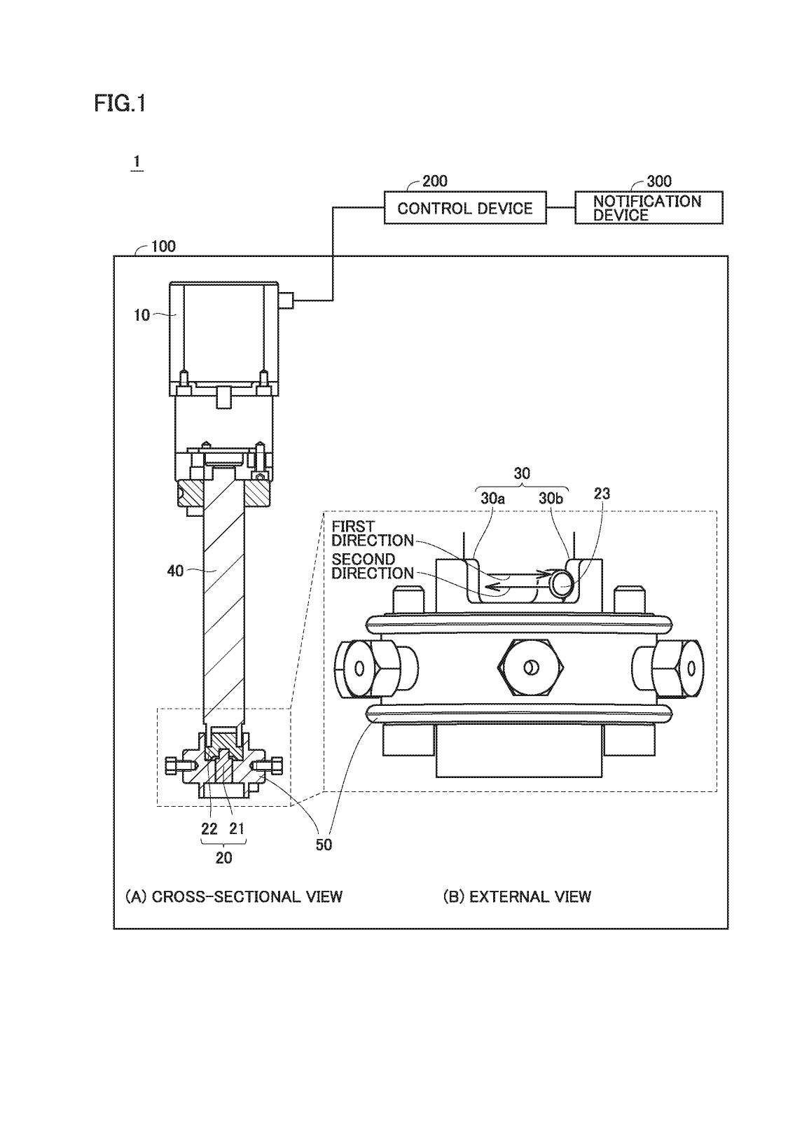

FIG. 1 is a diagram schematically showing a configuration of a drive control system 1 according to the present embodiment. The drive control system 1 includes a drive device 100, a control device 200 that controls the drive device 100, and a notification device 300.

The drive device 100 has a stepping motor 10, a displaceable part 20, a first connecting member 40, and a case member 50. The first connecting member 40 connects the stepping motor 10 and the displaceable part 20. The displaceable part 20 has a second connecting member 22 and a main body member 21. The second connecting member 22 connects the first connecting member 40 and the main body member 21. The second connecting member 22 has a protrusion 23. The case member 50 is arranged so as to surround the displaceable part 20.

The stepping motor 10 receives a pulse signal of current, which is a command for rotation, from the control device 200 and rotates. Along with the rotation of the stepping motor 10, the first connecting member 40 and the displaceable part 20 (the second connecting member 22 and the main body member 21) rotate integrally, and the protrusion 23 is displaced. At this time, the case member 50 does not rotate.

The stepping motor 10 is configured to be rotatable both clockwise and counterclockwise as viewed from the displaceable part 20. The direction in which the displaceable part 20 is displaced when the stepping motor 10 is rotated clockwise is opposite to the direction in which the displaceable part 20 is displaced when the stepping motor 10 is rotated counterclockwise. In the present embodiment, of the two directions in which the displaceable part 20 is displaced, the direction in which the protrusion 23 moves toward a restriction member 30b, which will be described later, is defined as a first direction, and the direction in which the protrusion 23 moves toward a restriction member 30a, which will be described later, is defined as a second direction.

In the present embodiment, the main body member 21 is a valve rotor, and the case member 50 is a valve body. That is, the main body member 21 and the case member 50 constitute a rotary valve that switches the flow path of a gas. When the stepping motor 10 is rotated and the main body member 21 rotates, the flow path is switched. Note that the main body member 21 and the case member 50 are not necessarily limited to being a rotary valve, and may be anything that exhibits some function by moving the main body member 21 to a desired position. Hereinafter, the control for rotating the stepping motor 10 to move the main body member 21 to a desired position and to cause it to exhibit the function provided in the main body member 21 will also be referred to as "normal control."

The case member 50 has a restriction member 30. In the present embodiment, there are two restriction members 30: a restriction member 30a and a restriction member 30b. The restriction members 30a and 30b are arranged at a predetermined distance from each other and restrict the displacement of the protrusion 23 by abutting against it. When the protrusion 23 abuts against the restriction member 30a, the displacement of the displaceable part 20 in the second direction is restricted. When the protrusion 23 abuts against the restriction member 30b, the displacement of the displaceable part 20 in the first direction is restricted. When the displacement of the displaceable part 20 is restricted, the stepping motor 10 steps out.

As described above, the control device 200 outputs a pulse signal of current to the stepping motor 10 as a command to rotate the stepping motor 10. The control device 200 also acquires the value of the back electromotive force generated in the coil of the stepping motor 10. The method for acquiring the value of the back electromotive force is not particularly limited, and any known method can be used. The control device 200 determines whether the stepping motor 10 has stepped out by a method described later, based on the acquired value of the back electromotive force. The control device 200 also has a memory for storing the result of the determination of whether the stepping motor 10 has stepped out. Furthermore, the control device 200 outputs a signal to the notification device 300.

The notification device 300 receives a signal from the control device 200 and notifies the user that the signal has been received. For example, the notification device 300 is a display device, which notifies the user by displaying on the screen that a signal has been received. Alternatively, the notification device 300 may be a speaker, which may notify the user by sound that a signal has been received.

### Determination of Abnormal Step-out

In order to move the displaceable part 20 to a desired position by the control of the control device 200 in normal control, the actual position of the displaceable part 20 and the position of the displaceable part 20 recognized by the control device 200 must be matched before performing the normal control. The control for matching these positions is the origin search.

In the present embodiment, the position of the displaceable part 20 when the protrusion 23 abuts against the restriction member 30a is taken as the origin in the displacement of the displaceable part 20. In the origin search in this case, the control device 200 outputs a rotation command to the stepping motor 10, the stepping motor 10 displaces the displaceable part 20 in the second direction, and the displacement of the displaceable part 20 is restricted by the restriction member 30a, thereby causing the stepping motor 10 to step out. Then, when it is determined that the stepping motor 10 has stepped out, the control device 200 recognizes that the displaceable part 20 is at the origin position. As a result, when the displaceable part 20 is actually at the origin position, the control device 200 recognizes that the displaceable part 20 is at the origin position. Consequently, the actual position of the displaceable part 20 and the position of the displaceable part 20 recognized by the control device 200 can be matched.

However, if an abnormal step-out occurs during the execution of the origin search, as described above, the control device 200 will recognize that the displaceable part 20 is at the origin position when the protrusion 23 is not in contact with the restriction member 30a and the displaceable part 20 is not actually at the origin position, making it impossible to execute the origin search correctly.

In view of such a problem, in the drive control system 1 according to the present embodiment, a determination is made as to whether an abnormal step-out of the stepping motor 10 will occur before the execution of the origin search. Specifically, the control device 200 first outputs a first command to the stepping motor to displace the displaceable part 20 in a first direction. Next, it outputs a second command to the stepping motor to displace the displaceable part 20 in a second direction. At this time, if the drive device 100 is in a first state where the stepping motor steps out both when it receives the first command and when it receives the second command, the control device 200 outputs a first abnormality signal indicating that the drive device 100 is in the first state. As a result, it is possible to determine whether an abnormal step-out of the stepping motor 10 will occur before the execution of the origin search.

To explain more specifically, when the protrusion 23 abuts against the restriction member 30a, the displacement of the displaceable part 20 in the direction toward the restriction member 30a from the abutting position is restricted, causing a step-out, but the displacement of the displaceable part 20 in the direction away from the restriction member 30a is not restricted, and no step-out occurs. This is also the case when the protrusion 23 abuts against the restriction member 30b. On the other hand, if the displaceable part 20 is stuck to a surrounding component (for example, the case member 50), a step-out will occur regardless of the direction in which the displaceable part 20 is attempted to be displaced.

In other words, the fact that the stepping motor 10 is in a first state where it steps out both when it receives the first command and when it receives the second command means that a step-out occurs regardless of the direction in which the displaceable part 20 is attempted to be displaced. This indicates that the displaceable part 20 is stuck to a surrounding component, that is, an abnormal step-out has occurred. The control device 200 can determine whether an abnormal step-out of the stepping motor 10 will occur by determining whether the drive device 100 is in the first state.

The control device 200 according to the present embodiment performs a first determination to determine whether the stepping motor 10 has stepped out as a result of receiving the first command, and performs a second determination to determine whether the stepping motor 10 has stepped out as a result of receiving the second command. Then, the control device 200 determines that the drive device 100 is in the first state if it is determined in both the first determination and the second determination that the stepping motor 10 has stepped out. This allows the control device 200 to determine whether an abnormal step-out of the stepping motor 10 has occurred.

In the first determination and the second determination, the control device 200 determines whether the stepping motor 10 has stepped out by a method described later, based on the value of the back electromotive force generated in the coil of the stepping motor 10.

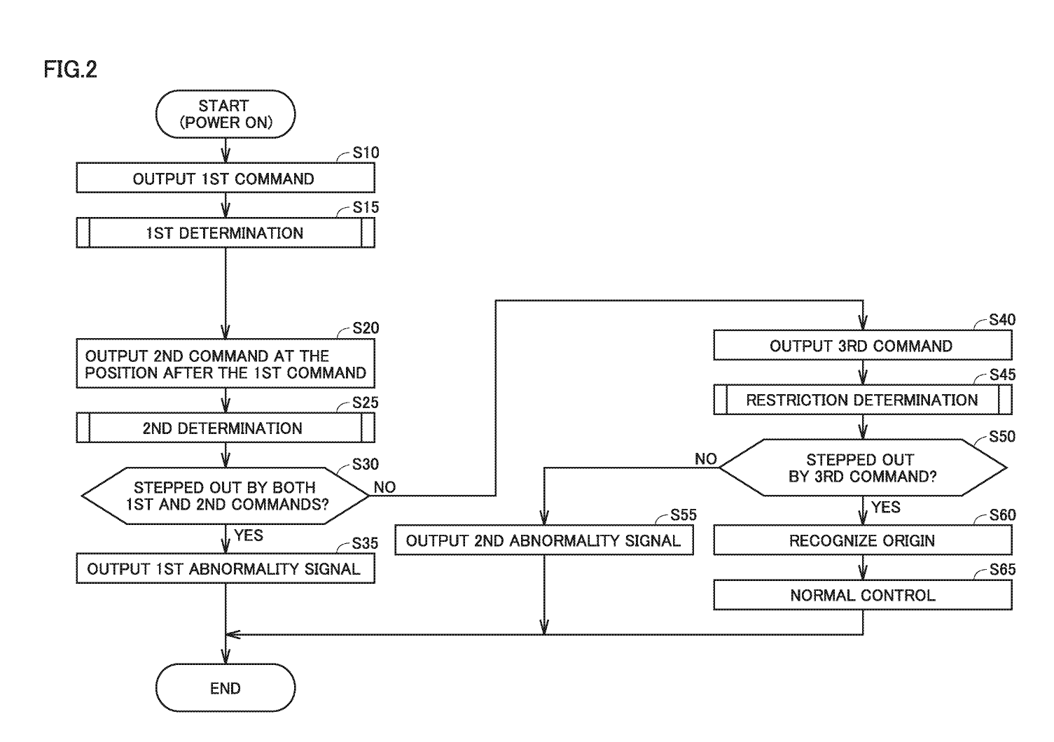

FIG. 2 is a flowchart showing an example of a procedure for the control device 200 to control the drive device 100. This flowchart is started before the drive control system 1 performs an origin search, and in the present embodiment, it is started when the power of the drive control system 1 is turned on. Steps S10 to S35 in the flowchart shown in FIG. 2 are the steps for determining whether an abnormal step-out of the stepping motor 10 will occur.

First, the control device 200 outputs a first command to the stepping motor 10 (Step S10). Specifically, a pulsed current that rotates the stepping motor 10 in the rotational direction corresponding to the first direction is passed through the coil of the stepping motor 10. Here, the number of current pulses corresponds to the angle of rotation of the stepping motor 10, that is, the displacement distance of the displaceable part 20. The displacement distance of the displaceable part 20 by the first command is shorter than the distance the displaceable part 20 would travel when displacing from a position where the protrusion 23 abuts against one of the restriction members 30a and 30b to a position where it abuts against the other.

Next, the control device 200 performs a first determination (Step S15). Specifically, it acquires the value of the back electromotive force generated in the coil of the stepping motor 10 when the stepping motor 10 receives the first command, and determines whether the stepping motor 10 has stepped out by a method described later. The result of the first determination is stored in memory.

Next, the control device 200 outputs a second command to the stepping motor 10 for the displaceable part 20, which is at the position where it has finished displacing based on the first command (Step S20). Specifically, a pulsed current that rotates the stepping motor 10 in the rotational direction corresponding to the second direction is passed through the coil of the stepping motor 10. The displacement distance of the displaceable part 20 by the second command is, similar to the first command, shorter than the distance the displaceable part 20 would travel when displacing from a position where the protrusion 23 abuts against one of the restriction members 30a and 30b to a position where it abuts against the other. Note that the position of the displaceable part 20 after finishing displacement based on the first command differs depending on the timing of step-out and the presence or absence of step-out while the stepping motor 10 is receiving the first command. That is, the position of the displaceable part 20 after finishing displacement based on the first command is, for example, the same position as before the first command if the stepping motor 10 stepped out before the displaceable part 20 started to displace, and is a position after displacing partway through the intended displacement distance of the first command if the stepping motor 10 stepped out while receiving the first command. Furthermore, if the stepping motor 10 did not step out, it is the position after the displaceable part 20 has been displaced by the displacement distance of the first command.

Next, the control device 200 performs a second determination (Step S25). Specifically, it acquires the value of the back electromotive force generated in the coil of the stepping motor 10 when the stepping motor 10 receives the second command, and determines whether the stepping motor 10 has stepped out by a method described later. The result of the second determination is stored in memory.

Next, the control device 200 retrieves the determination results of the first determination and the second determination from memory and checks whether it was determined that the stepping motor stepped out in both the first determination and the second determination (Step S30).

Then, if it is confirmed that it was determined in both the first determination and the second determination that the stepping motor stepped out (YES in Step S30), the control device 200 determines that the drive device 100 is in the first state and outputs a first abnormality signal to the notification device 300 (Step S35).

As described above, the control device 200 according to the present embodiment outputs a first command to the stepping motor, performs a first determination, outputs a second command to the stepping motor, and performs a second determination. If it is determined in both the first determination and the second determination that the stepping motor 10 has stepped out, the control device 200 determines that the drive device 100 is in the first state. This allows the control device 200 to determine whether the state of the drive device 100 is the first state. Then, the control device 200 outputs a first abnormality signal indicating that the drive device 100 is in the first state. As a result, it is possible to determine whether an abnormal step-out of the stepping motor 10 will occur.

On the other hand, if it is not confirmed that the stepping motor stepped out in both the first and second determinations (NO in step S30), it is assumed that no abnormal step-out has occurred, and the control device 200 performs an origin search.

First, the control device 200 outputs a third command to the stepping motor 10 (step S40). Specifically, a pulsed current is passed through the coil of the stepping motor 10 to rotate the stepping motor 10 in the rotational direction corresponding to the direction in which the displaceable part 20 moves toward the restriction member 30a. The displacement distance of the displaceable part 20 by the third command is, for example, longer than the distance the displaceable part 20 would travel when displacing from a position where the protrusion 23 abuts against one of the restriction members 30a and 30b to a position where it abuts against the other.

Next, the control device 200 performs a restriction determination (step S45). Specifically, it acquires the value of the back electromotive force generated in the coil of the stepping motor 10 when the stepping motor 10 receives the third command and determines whether the stepping motor 10 has stepped out by a method described later. The result of the restriction determination is stored in memory.

Next, the control device 200 retrieves the result of the restriction determination from memory and checks whether it was determined that the stepping motor 10 has stepped out (step S50).

Next, if it is confirmed in the restriction determination that the stepping motor 10 has stepped out (YES in step S50), the control device 200 recognizes that the displaceable part 20 is at the origin position (step S60). Specifically, it sets the coordinate of the position of the displaceable part 20 at the time of said determination to 0. At this point, since it has already been determined that no abnormal step-out will occur, if it is determined in the restriction determination that the stepping motor 10 has stepped out, it means that the displacement of the displaceable part 20 was restricted by the restriction member 30a, causing the stepping motor 10 to step out. In other words, the protrusion 23 is at the position where it abuts against the restriction member 30a, and the displaceable part 20 is actually at the origin position.

After recognizing that the displaceable part 20 is at the origin position, the control device 200 performs normal control (step S65). Specifically, it calculates the rotation angle of the stepping motor 10 to move the displaceable part 20 from the origin position to a desired position, and rotates the stepping motor 10 to move the displaceable part 20 to the desired position, thereby performing control to exhibit the valve function provided in the main body member 21.

Furthermore, if it is confirmed in the restriction determination that the stepping motor did not step out (NO in step S50), the control device 200 outputs a second abnormality signal to the notification device 300, indicating that the drive control system 1 is in a second state (step S55). The second state is, for example, a state where the stepping motor 10 and the displaceable part 20 are not connected, or a state where the threshold value (described later) for determining whether the stepping motor 10 has stepped out is set to an incorrect value.

As described above, in the drive control system 1 according to the present embodiment, if the control device 200 confirms that the stepping motor 10 did not step out in at least one of the first determination and the second determination, it outputs a third command to the stepping motor 10 and performs a restriction determination. If it is confirmed in the restriction determination that the stepping motor 10 has stepped out, the control device 200 recognizes that the displaceable part 20 is at the origin position at the time of said determination. This allows the actual position of the displaceable part 20 and the position of the displaceable part 20 recognized by the control device 200 to be matched. If it is confirmed in the restriction determination that the stepping motor 10 did not step out, the control device 200 outputs a second abnormality signal indicating that it is in the second state. This allows for the determination that the state of the drive control system 1 is the second state, in which it is not possible to determine whether the stepping motor 10 has stepped out.

Furthermore, in the present embodiment, the notification device 300 receives the first abnormality signal and notifies the user that the first abnormality signal has been received. This allows the user to know that the drive device 100 is in the first state. As a result, the user can take measures to resolve the first state, for example, measures to resolve the sticking between the displaceable part 20 and its surrounding components.

Furthermore, in the present embodiment, the notification device 300 receives the second abnormality signal and notifies the user that the second abnormality signal has been received. This allows the user to know that the drive device 100 is in the second state. As a result, the user can take measures to resolve the second state, for example, measures to connect the stepping motor 10 and the displaceable part 20.

Furthermore, in the present embodiment, the control device 200 sets the current value supplied to the stepping motor 10 in the first command (hereinafter also referred to as "first current value"), the current value supplied to the stepping motor 10 in the second command (hereinafter also referred to as "second current value"), and the current value supplied to the stepping motor 10 in the third command (hereinafter also referred to as "third current value") to be all smaller than the current value supplied to the stepping motor 10 in normal control (hereinafter also referred to as "normal current value").

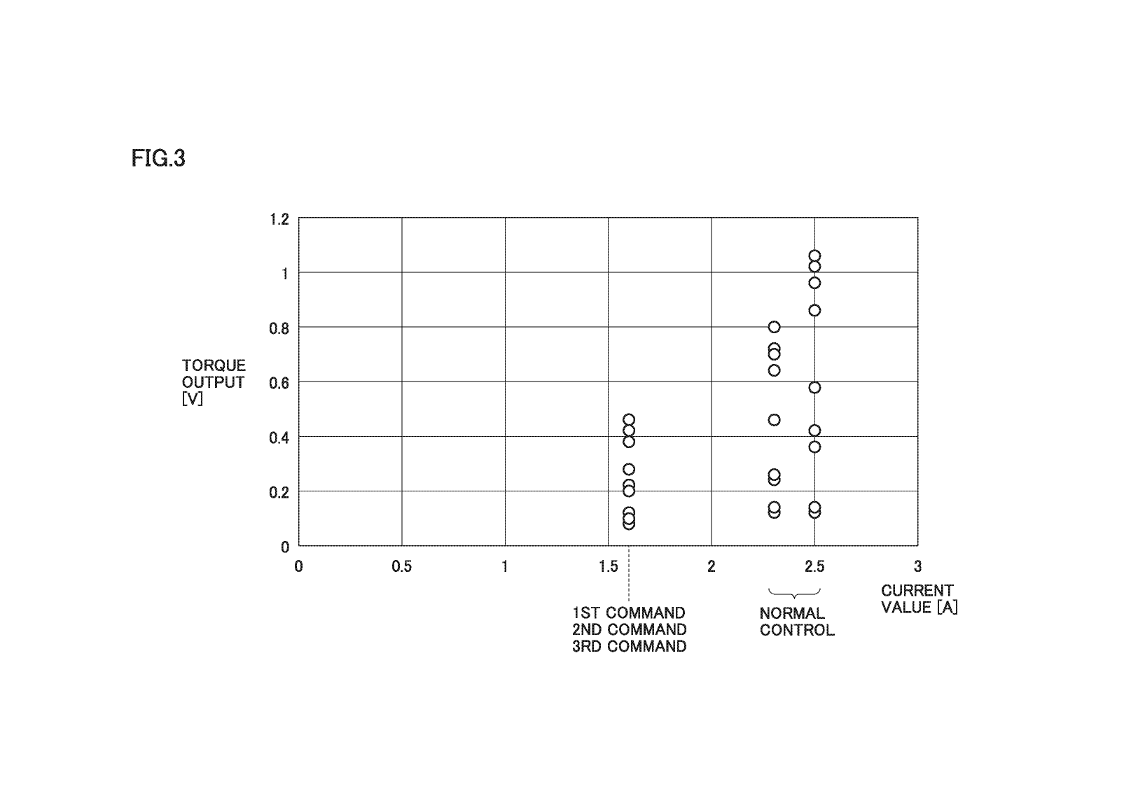

Specifically, the smaller the current value flowing through the stepping motor 10, the smaller the output torque of the stepping motor 10 at the time of step-out. FIG. 3 is a diagram showing an example of the output torque of the stepping motor 10 at the time of step-out versus the current value flowing through the stepping motor 10. It shows the results of measuring the output torque at step-out of the stepping motor 10 ten times each when the current value flowing through the stepping motor 10 was set to 1.6 [A], 2.3 [A], and 2.5 [A], respectively. The maximum value of the output torque at step-out of the stepping motor 10 in the ten measurements for each current value is smaller as the current value flowing through the stepping motor 10 is smaller.

Let the normal current value be 2.3 [A] or 2.5 [A], and let the first current value, the second current value, and the third current value be 1.6 [A]. Then, since both the first current value and the second current value are smaller than the normal current value, the output torque of the stepping motor 10 at step-out when receiving the first command and the output torque of the stepping motor 10 at step-out when receiving the second command are both likely to be smaller than the output torque of the stepping motor 10 at step-out during normal control. Here, an abnormal step-out of the stepping motor 10 occurs when the output torque of the stepping motor 10 at step-out is smaller than the load on the rotation of the stepping motor 10. Therefore, the stepping motor 10 will step out in response to the first and second commands even with a weaker load than the load that would cause the stepping motor 10 to step out in response to the first and second commands if the first and second current values were the same as the normal current value. This makes it easier to cause a step-out with the first and second commands even when the force causing the abnormal step-out (for example, the sticking force between the displaceable part 20 and its surrounding components) is weak, thereby making it easier to determine that the system is in the first state.

Furthermore, since the third current value is smaller than the normal current value, when the protrusion 23 of the displaceable part 20 abuts against the restriction member 30a in the third command, the stepping motor 10 steps out while suppressing the deflection of the restriction member 30a by the protrusion 23, as compared to the case where the third current value is the same as the normal current value. This allows the control device 200 to match the actual position of the displaceable part 20 and the position of the displaceable part 20 recognized by the control device 200 more accurately.

Furthermore, in the present embodiment, the control device 200 utilizes the phenomenon where a back electromotive force corresponding to the rotational speed of the stepping motor 10 is generated in the coil of the stepping motor 10, and determines whether the stepping motor 10 has stepped out based on the value of the back electromotive force.

Specifically, it is known that the back electromotive force generated in the coil of the stepping motor 10 increases as the rotational speed of the stepping motor 10 increases. When the stepping motor 10 steps out, its rotation stops, so the back electromotive force takes a small value. The control device 200 acquires the value of the back electromotive force during the period when a pulsed current, which is a rotation command, is being supplied to the stepping motor 10 (hereinafter also referred to as "command period"). Then, the control device 200 has a preset threshold value for the back electromotive force value, and determines that the stepping motor 10 has stepped out if the back electromotive force value falls below the threshold value for at least a partial period within the command period.

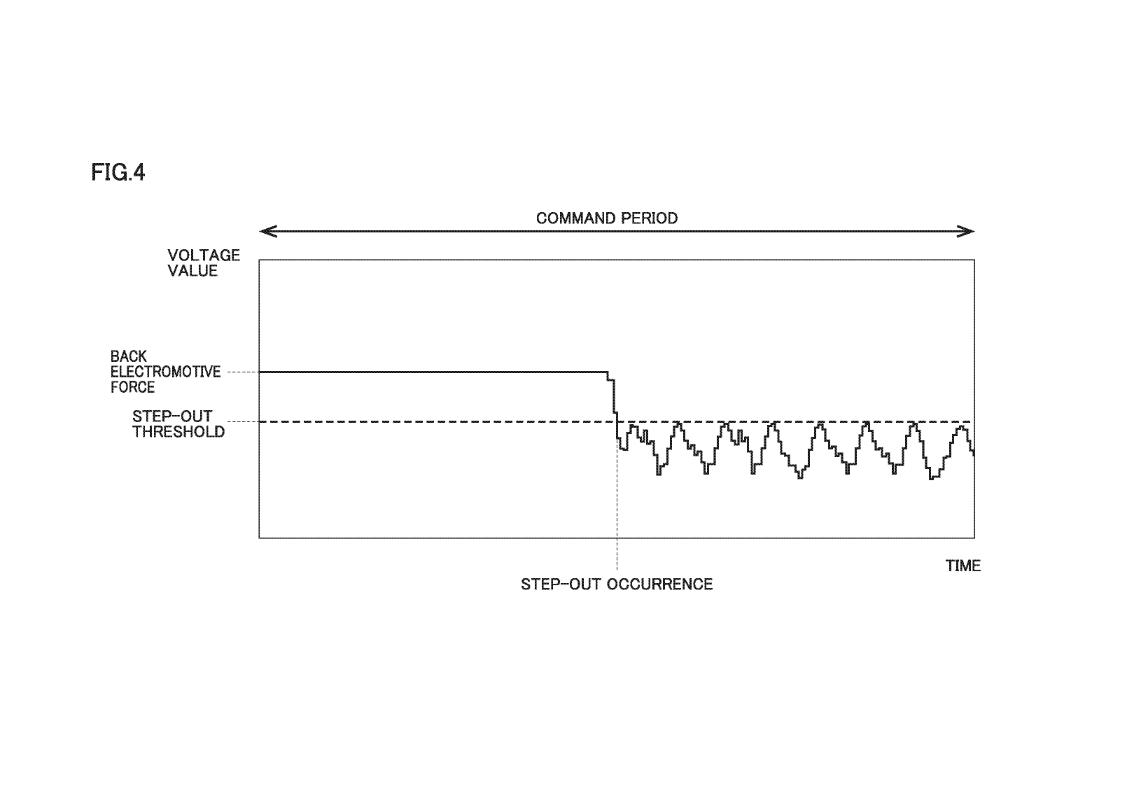

FIG. 4 is a diagram showing an example of the back electromotive force acquired by the control device 200. From the start of the command period until the timing of the step-out occurrence, the value of the back electromotive force is constant and larger than the threshold value. At this time, the stepping motor 10 has not stepped out and is rotating according to the rotation command. On the other hand, from the timing of the step-out occurrence until the end of the command period, the value of the back electromotive force is smaller than the threshold value. At this time, the stepping motor 10 has stepped out and its rotation has stopped. If the stepping motor 10 steps out immediately after the command period starts, the timing of the step-out occurrence will naturally be earlier than the time shown in FIG. 4.

At this time, a threshold value for the back electromotive force (dashed line in FIG. 4) is set. From the timing of the step-out occurrence until the end of the command period, the value of the back electromotive force is below the threshold value. This allows the control device 200 to determine that the stepping motor 10 has stepped out.

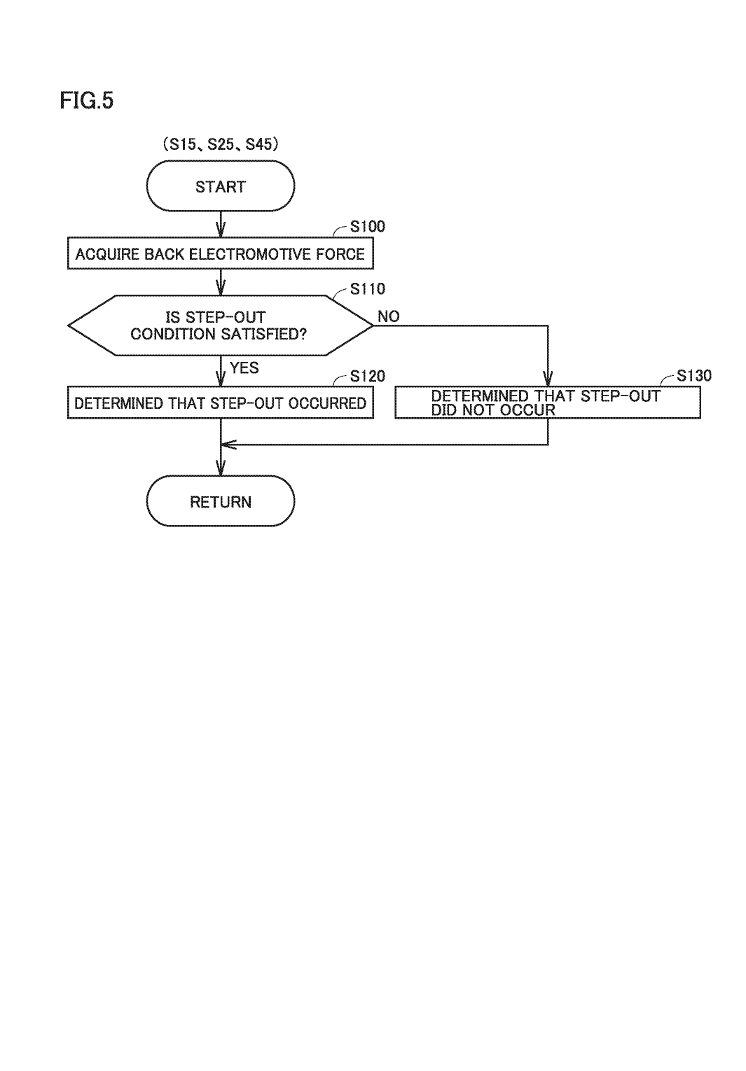

FIG. 5 is a flowchart showing an example of a procedure for determining whether the stepping motor 10 has stepped out based on the value of the back electromotive force. This flowchart is initiated when performing the first determination (Step S15), the second determination (Step S25), and the restriction determination (Step S45).

First, in parallel with supplying a pulsed current to the stepping motor 10, the control device 200 acquires the value of the back electromotive force generated in the coil of the stepping motor 10 (Step S100).

Furthermore, in parallel with acquiring the value of the back electromotive force generated in the coil of the stepping motor 10, the control device 200 determines whether a step-out condition related to the back electromotive force value is satisfied (Step S110). Specifically, a threshold value for the back electromotive force value is preset, and if the back electromotive force value falls below the threshold value for at least a partial period within the command period, it is determined that the step-out condition is satisfied.

Then, if the step-out condition is satisfied (YES in Step S110), the control device 200 determines that the stepping motor 10 has stepped out (Step S120), and if the step-out condition is not satisfied (NO in Step S110), it determines that the stepping motor 10 has not stepped out (Step S130).

In addition to this method using the value of the back electromotive force, there is a method of determining whether the stepping motor 10 has stepped out using the amount of rotation of the stepping motor 10 or the displacement distance of the displaceable part 20. However, in that case, it would be necessary to newly install a measuring device such as an encoder to measure the rotation amount of the stepping motor 10, or a distance sensor to measure the displacement distance of the displaceable part 20. Furthermore, depending on the installation environment of the stepping motor 10 or the displaceable part 20, for example, in a high-temperature environment, these measuring devices may be damaged.

In other words, by relying on the value of the back electromotive force, the control device 200 determines whether the stepping motor 10 has stepped out without newly providing a measuring device to measure the rotation amount or displacement distance. As a result, it is possible to determine whether the stepping motor 10 has stepped out, regardless of the installation environment, while reducing the cost of the components of the drive control system 1.

Modification 1 In the embodiment described above, the process of determining the presence or absence of an abnormal step-out (step S30) is performed after the first determination (step S15) and the second determination (step S25). However, if it is determined in the first determination that the stepping motor 10 has not stepped out, it may be assumed at that point that no abnormal step-out has occurred, and the process may be moved to step S40 without performing the processes from step S20 onwards.

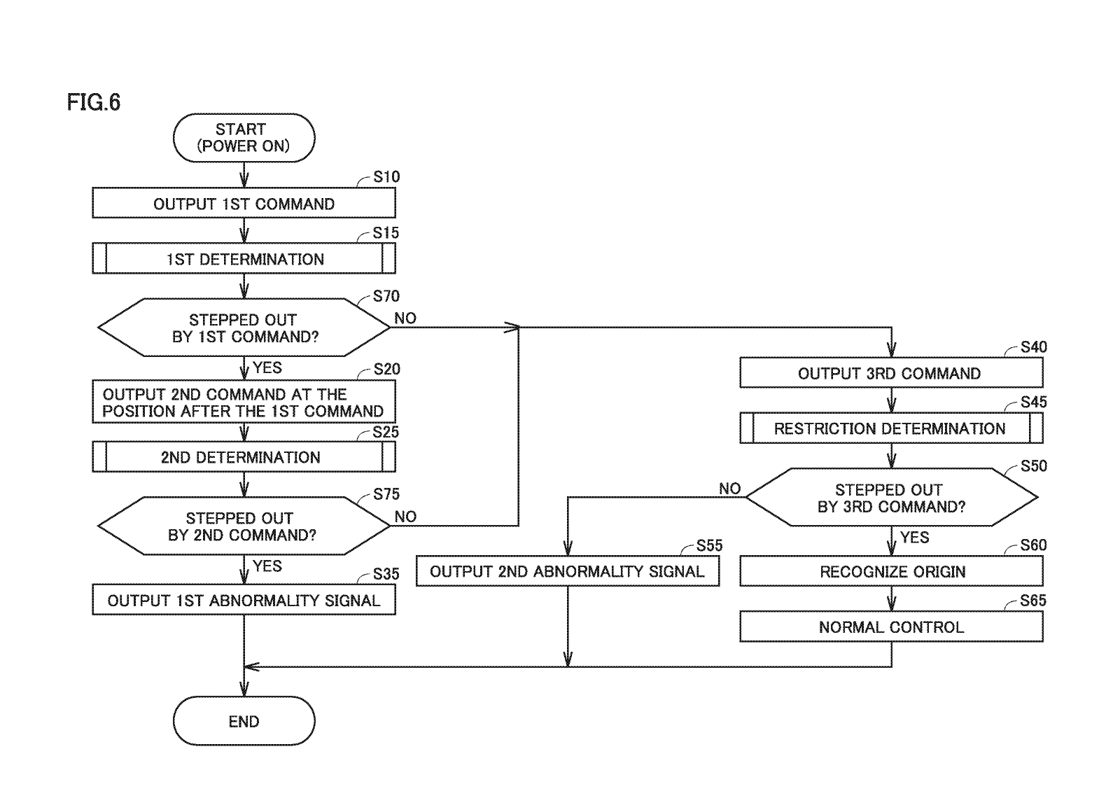

FIG. 6 is a flowchart showing an example of a procedure for the control device 200 to control the drive device 100 in this Modification 1. The flowchart in FIG. 6 is a modification of the flowchart in FIG. 2, where step S30 is changed to step S75, and step S70 is added. The other steps in FIG. 6 (steps with the same numbers as those shown in FIG. 2) have already been described, so a detailed explanation is not repeated here.

After the first determination (Step S15), the control device 200 retrieves the result of the first determination from memory and checks whether it was determined in the first determination that the stepping motor 10 has stepped out (Step S70).

If it is confirmed that it was determined in the first determination that the stepping motor 10 has stepped out (YES in Step S70), the control device 200 outputs a second command to the stepping motor 10 (Step S20) and performs a second determination (Step S25).

Next, the control device 200 retrieves the result of the second determination from memory and checks whether it was determined in the second determination that the stepping motor 10 has stepped out (Step S75).

Then, if it is confirmed that it was determined in the second determination that the stepping motor stepped out (YES in Step S75), the control device 200 determines that the drive device 100 is in the first state and outputs a first abnormality signal (Step S35).

On the other hand, if it is confirmed that it was determined in the first determination that the stepping motor 10 did not step out (NO in step S70), the control device 200 proceeds to step S40 to perform the processes from step S40 onwards, without performing the processes from step S20 onwards.

As described above, if the control device 200 according to this Modification 1 determines in the first determination that the stepping motor 10 did not step out, it assumes that no abnormal step-out has occurred, and does not output a second command to the stepping motor or perform a second determination. This reduces the processing performed by the control device 200 and can shorten the time required to determine whether the drive device 100 is in the first state.

### Modification 2

In the above-described embodiment, the process (step S30) for determining the presence of an abnormal step-out is performed after conducting the first determination (step S15) and the second determination (step S25). However, the first determination (step S15) may be omitted.

To explain specifically, it is assumed that the distance the displaceable part 20 is displaced in the second command is less than or equal to the distance the displaceable part 20 is displaced in the first command. At this time, if the stepping motor 10 did not step out when it received the first command, it means that the protrusion 23 did not abut against the restriction member 30 during the displacement of the displaceable part 20 in the first command. Then, in the subsequent second command, since the direction of displacement of the displaceable part 20 is opposite to the direction in the first command, and the displacement distance is less than or equal to the distance in the first command, the protrusion 23 will not abut against the restriction member 30 during the displacement of the displaceable part 20 in the second command either.

Conversely, if the stepping motor 10 stepped out when it received the second command, it implies that the stepping motor 10 also stepped out when it received the first command, that is, it is in the first state where the stepping motor steps out both when it receives the first command and when it receives the second command.

In other words, the first determination does not need to be performed. Therefore, the first determination (step S15) may be omitted.

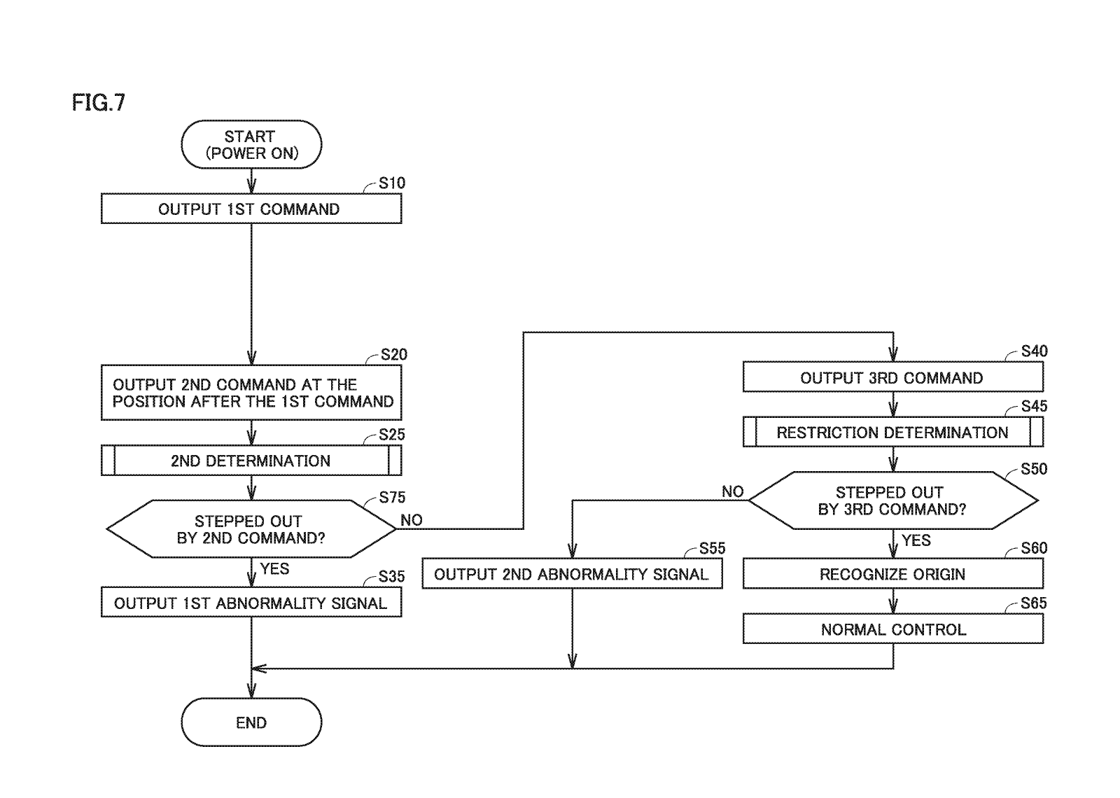

FIG. 7 is a flowchart illustrating an example of the procedure by which the control device 200 controls the drive device 100 in this Modification 2. The flowchart in FIG. 7 is derived from the flowchart in FIG. 6 by deleting steps S15 and S70.

As described above, the control device 200 according to this Modification 2 omits the first determination described above (step S15 in FIG. 2 or FIG. 6) and determines whether the system is in the first state based on the result of the second determination (step S75). This eliminates the need for the first determination, reduces the processing performed by the control device 200, and can shorten the time required to determine whether the drive device 100 is in the first state.

### Other Modifications

In the present embodiment, it was described that when the stepping motor 10 rotates, the displaceable part 20 rotates via the first connecting member 40, but the invention is not limited to this. For example, the first connecting member 40 may be a mechanism that converts the rotation of the stepping motor 10 into linear motion, and the displaceable part 20 may move linearly.

In the present embodiment, the direction in which the protrusion 23 moves toward the restriction member 30b was defined as the first direction, the direction in which the protrusion 23 moves toward the restriction member 30a was defined as the second direction, and the position of the displaceable part 20 when the protrusion 23 abuts against the restriction member 30a was defined as the origin of the displacement of the displaceable part 20, but the present invention is not limited to this. The direction in which the protrusion 23 moves toward the restriction member 30a may be defined as the first direction and the direction in which the protrusion 23 moves toward the restriction member 30b as the second direction, while keeping the position of the displaceable part 20 when the protrusion 23 abuts against the restriction member 30a as the origin of the displacement of the displaceable part 20.

In the present embodiment, there are two restriction members 30, namely restriction member 30a and restriction member 30b, but the invention is not limited to this, and there may be only one restriction member 30. In this case, the origin of the displacement of the displaceable part 20 would be the position where the protrusion 23 abuts against the restriction member 30. Also, the displacement distance of the displaceable part 20 in the third command may be, for example, set to a distance longer than the distance required to displace from the position where the protrusion 23 is furthest from the restriction member 30 to the position where it abuts against the restriction member 30, based on the structure of the displaceable part 20 and the case member 50.

In the present embodiment, if there is play between the rotation of the stepping motor 10 and the displacement of the displaceable part 20, the rotation angle for rotating the stepping motor 10 in the first command, the second command, and the third command shall be greater than the rotation angle corresponding to that play. This ensures that even when there is play, the stepping motor 10 rotates by the rotation angle that displaces the displaceable part 20 in the first, second, and third commands, thereby preventing a determination that the stepping motor 10 did not step out due to the play.

In the present embodiment, the control device 200 determined whether the stepping motor 10 stepped out based on the value of the back electromotive force, but the invention is not limited to this. For example, it may be determined whether the stepping motor 10 has stepped out based on the value of the rotational speed of the stepping motor 10 or the value of the output torque of the stepping motor 10, calculated based on the value of the back electromotive force.

In the present embodiment, the main body member 21 and the case member 50 were described as a rotary valve for switching the flow path of a gas, but the present invention is not limited to this. The fluid may be a liquid instead of a gas, that is, it may be any fluid.

In the present embodiment, in the procedure for determining whether the stepping motor 10 has stepped out based on the value of the back electromotive force, it was described that the control device 200 acquires the value of the back electromotive force generated in the coil of the stepping motor 10 and determines whether the step-out condition related to the back electromotive force value is satisfied in parallel with supplying a pulsed current to the stepping motor 10, but the invention is not limited to this. The control device 200 may store the acquired back electromotive force values in memory, and after the acquisition of the back electromotive force values is completed, that is, after the supply of the pulsed current to the stepping motor 10 is finished, read the back electromotive force values from the memory to determine whether the step-out condition related to the back electromotive force value is satisfied.

### Aspects

Those skilled in the art will understand that the above-described embodiment and its modifications are specific examples of the following aspects.

(Item 1) A drive control system according to one aspect includes a drive device and a control device that controls the drive device. The drive device has a stepping motor that rotates upon receiving a command from the control device, and a displaceable part connected to the stepping motor, which is displaced by the rotation of the stepping motor. The control device outputs a first command to the stepping motor to displace the displaceable part in a first direction, performs a first determination to determine a step-out of the stepping motor based on the first command, and at the position where the displaceable part has finished displacing based on the first command, outputs a second command to the stepping motor to displace the displaceable part in a second direction different from the first direction, performs a second determination to determine a step-out of the stepping motor based on the second command, and if the stepping motor is in a first state where it steps out both when it receives the first command and when it receives the second command, outputs a first abnormality signal indicating that it is in the first state.

According to the drive control system described in Item 1, when the displaceable part, which is displaced by the rotation of the stepping motor, abuts against a restriction member, the displacement of the displaceable part in the direction of the restriction member is restricted, causing a step-out, but the displacement of the displaceable part in the direction opposite to the restriction member is not restricted, and no step-out occurs. On the other hand, if the displaceable part is stuck to a surrounding component, a step-out will occur regardless of the direction in which the displaceable part is attempted to be displaced. Based on this, the control device outputs a first command to the stepping motor to displace the displaceable part in a first direction, as well as a second command to the stepping motor to displace the displaceable part in a second direction, and performs a first determination to determine a step-out of the stepping motor based on the first command and a second determination to determine a step-out of the stepping motor based on the second command. If the system is in a first state where a step-out occurs in response to both the first and second commands, it is determined that the step-out is an abnormal step-out, and a first abnormality signal is output. As a result, it is possible to determine whether an abnormal step-out of the stepping motor will occur.

(Item 2) In the drive control system according to Item 1, the control device further does not output the second command to the stepping motor if it is determined in the first determination that the stepping motor did not step out, and outputs the second command to the stepping motor and performs the second determination if it is determined in the first determination that the stepping motor did step out. The control device outputs the first abnormality signal, indicating the first state, if it is determined in the second determination that the stepping motor did step out.

According to the drive control system described in Item 2, if it is determined in the first determination that the stepping motor did not step out, it is assumed that no abnormal step-out has occurred, and the second command is not output to the stepping motor, and the second determination is not performed. This reduces the processing performed by the control device and can shorten the time required to determine whether the drive device is in the first state.

(Item 3) In the drive control system according to Item 1, the drive device further has a restriction member that restricts the displacement of the displaceable part in one direction at a predetermined position. The stepping motor steps out when the displacement of the displaceable part is restricted by the restriction member. If not in the first state, the control device further outputs a third command to the stepping motor to displace the displaceable part so that its displacement is restricted by the restriction member, performs a restriction determination to determine whether the stepping motor has stepped out as a result of receiving the third command, and if it is determined in the restriction determination that the stepping motor did not step out, outputs a second abnormality signal indicating a second state in which it is not possible to determine whether the stepping motor has stepped out.

According to the drive control system described in Item 3, if the control device determines that the stepping motor did not step out despite having output a third command to the stepping motor to displace the displaceable part such that its displacement is restricted by the restriction member, it outputs a second abnormality signal indicating the second state. This allows the control device to determine whether the state of the drive control system is the second state, in which it is not possible to determine whether the stepping motor has stepped out.

(Item 4) In the drive control system according to Item 3, if it is determined in the restriction determination that the stepping motor has stepped out, the control device recognizes that the displaceable part is at the origin position at the time of said determination.

According to the drive control system of Item 4, the control device can match the actual position of the displaceable part with the position of the displaceable part recognized by the control device.

(Item 5) In the drive control system according to Item 4, after recognizing that the displaceable part is at the origin position, the control device controls the stepping motor with a first current value. The current value flowing through the stepping motor when it receives the first command, the current value flowing through the stepping motor when it receives the second command, and the current value flowing through the stepping motor when it receives the third command are all smaller than the first current value.

According to the drive control system of Item 5, a step-out will occur in response to the first and second commands even with a weaker load than the load that would cause the stepping motor to step out in response to the first and second commands if the first and second current values were the same as the normal current value. This makes it possible to determine that the system is in the first state even when the degree of abnormality causing the abnormal step-out is weaker, for example, when the degree of sticking between the displaceable part and its surrounding components is weaker. Furthermore, if the stepping motor steps out in response to the third command, the actual position of the displaceable part and the position of the displaceable part recognized by the control device can be matched more accurately.

(Item 6) In the drive control system according to any one of Items 1 to 3, a back electromotive force corresponding to the rotational speed of the stepping motor is generated in the coil of the stepping motor. When determining whether the stepping motor has stepped out, the control device acquires the value of the back electromotive force and determines whether the stepping motor has stepped out based on the value of the back electromotive force.

According to the drive control system described in Item 6, by relying on the value of the back electromotive force, it is possible to determine whether the stepping motor has stepped out without newly providing a measuring device to measure the rotation amount of the stepping motor or the displacement distance of the displaceable part. As a result, it is possible to determine whether the stepping motor has stepped out, regardless of the installation environment, while reducing the cost of the components of the drive control system.

(Item 7) The drive control system according to Item 1 further comprises a notification device that receives the first abnormality signal and notifies a user that the first abnormality signal has been received.

According to the drive control system described in Item 7, the user can be informed by the notification device that the drive device is in the first state.

(Item 8) The drive control system according to Item 3 further comprises a notification device that receives the second abnormality signal and notifies a user that the second abnormality signal has been received.

According to the drive control system described in Item 8, the user can be informed by the notification device that the drive control system is in the second state.

The embodiments disclosed herein should be considered in all respects as illustrative and not restrictive. The scope of the present invention is indicated by the appended claims rather than by the foregoing description, and all changes which come within the meaning and range of equivalency of the claims are intended to be embraced therein.

### REFERENCE SIGNS LIST

1 Drive control system, 10 Stepping motor, 20 Displaceable part, 21 Main body member, 22 Second connecting member, 23 Protrusion, 50 Case member, 30, 30a, 30b Restriction member, 40 First connecting member, 100 Drive device, 200 Control device, 300 Notification device.

1. A drive control system, comprising:
a drive device; and
a control device configured to control the drive device,
wherein the drive device comprises:
a stepping motor configured to rotate upon receiving a command from the control device; and
a displaceable part connected to the stepping motor and configured to be displaced by rotation of the stepping motor,
and wherein the control device is configured to:
output a first command to the stepping motor to displace the displaceable part in a first direction;
perform a first determination to determine a step-out of the stepping motor based on the first command;
at a position where the displaceable part has finished displacing based on the first command, output a second command to the stepping motor to displace the displaceable part in a second direction different from the first direction;
perform a second determination to determine a step-out of the stepping motor based on the second command; and
if the stepping motor is in a first state where it steps out both when receiving the first command and when receiving the second command, output a first abnormality signal indicating the first state.

2. The drive control system according to claim 1, wherein the control device is further configured to:
refrain from outputting the second command to the stepping motor if it is determined in the first determination that the stepping motor did not step out;
output the second command to the stepping motor and perform the second determination if it is determined in the first determination that the stepping motor did step out; and
wherein the control device is configured to output the first abnormality signal, indicating the first state, if it is determined in the second determination that the stepping motor did step out.

3. The drive control system according to claim 1,
wherein the drive device further comprises a restriction member configured to restrict displacement of the displaceable part in one direction at a predetermined position,
wherein the stepping motor is configured to step out when displacement of the displaceable part is restricted by the restriction member,
and wherein the control device, if not in the first state, is further configured to:
output a third command to the stepping motor to displace the displaceable part such that displacement of the displaceable part is restricted by the restriction member;
perform a restriction determination to determine whether the stepping motor has stepped out as a result of receiving the third command; and
if it is determined in the restriction determination that the stepping motor did not step out, output a second abnormality signal indicating a second state in which it is not possible to determine whether the stepping motor has stepped out.

4. The drive control system according to claim 3, wherein the control device is configured to, if it is determined in the restriction determination that the stepping motor has stepped out, recognize that the displaceable part is at an origin position at a time of said determination.

5. The drive control system according to claim 4,
wherein the control device is configured to control the stepping motor with a first current value after recognizing that the displaceable part is at the origin position,
and wherein a current value flowing through the stepping motor when receiving the first command, a current value flowing through the stepping motor when receiving the second command, and a current value flowing through the stepping motor when receiving the third command are all smaller than the first current value.

6. The drive control system according to claim 1,
wherein a back electromotive force corresponding to a rotational speed of the stepping motor is generated in a coil of the stepping motor,
and wherein the control device, when determining whether the stepping motor has stepped out, is configured to:
acquire a value of the back electromotive force; and
determine whether the stepping motor has stepped out based on the value of the back electromotive force.

7. The drive control system according to claim 1, further comprising a notification device configured to receive the first abnormality signal and notify a user that the first abnormality signal has been received.

8. The drive control system according to claim 3, further comprising a notification device configured to receive the second abnormality signal and notify a user that the second abnormality signal has been received.
